(19) United States
(12) Patent Application Publication
(10) Pub. No.: US 2026/0114579 A1
(43) Pub. Date: Apr. 30, 2026

(54) PERISTALTIC GEAR SHIFTING MOTOR

(71) Applicant: L'Oreal, Paris (FR)

(72) Inventors: Ayoub HBAICH, Franklin Park, NJ (US); Rafael FELICIANO, New Providence, NJ (US)

(73) Assignee: L'Oreal, Paris (FR)

(21) Appl. No.: 18/933,988

(22) Filed: Oct. 31, 2024

(51) Int. Cl. A45D 24/22; B67D 7/66

(52) U.S. Cl. CPC A45D 24/22; B67D 7/66

(57) ABSTRACT

A dispenser system, including a first shaft and a second shaft, a first gear system disposed on the first shaft, the first gear system including a first gear, a second gear, a first pump roller configured to dispense a first formula, and a second pump roller configured to dispense a second formula, and a second gear system disposed on the second shaft, the second gear system including a third gear, a fourth gear, and a synchronizer configured to slide between the third gear and the fourth gear, and a motor configured to rotate the first shaft and the second shaft, wherein the motor is configured to control both the first pump roller and the second pump roller.

### SUMMARY

In one aspect, disclosed herein is a dispenser system, including a first shaft and a second shaft, a first gear system disposed on the first shaft, the first gear system including a first gear, a second gear, a first pump roller configured to dispense a first formula, and a second pump roller configured to dispense a second formula, a second gear system disposed on the second shaft, the second gear system including a third gear, a fourth gear, and a synchronizer configured to slide between the third gear and the fourth gear, and a motor configured to rotate the first shaft and the second shaft, wherein the motor is configured to control both the first pump roller and the second pump roller.

In some embodiments, the first gear is configured to engage the third gear. In some embodiments, the second gear is configured to engage the fourth gear.

In some embodiments, a gear ratio of the first gear to the third gear is 1:1. In some embodiments, a gear ratio of the second gear to the fourth gear is 2:1.

In some embodiments, the first gear is fixed. In some embodiments, the second gear is fixed. In some embodiments, the third gear is free spinning. In some embodiments, the fourth gear is free spinning.

In some embodiments, the first formula is different from the second formula. In some embodiments, a gear ratio of the first gear and the third gear controls a flow rate of the first formula and the second formula. In some embodiments, a gear ratio of the first gear and the third gear controls a mix ratio between the first formula and the second formula. In some embodiments, a gear ratio of the second gear and the fourth gear controls a flow rate of the first formula and the second formula. In some embodiments, a gear ratio of the second gear and the fourth gear controls a mix ratio of the first formula and the second formula.

In some embodiments, the synchronizer slides laterally along fixed shaft splines of the second shaft. In some embodiments, the third gear comprises a third gear attachment configured to removably couple to the synchronizer.

In some embodiments, the fourth gear comprises a fourth gear attachment configured to removably couple to the synchronizer. In some embodiments, the second gear system further comprises a fixed secondary gear.

In some embodiments, the first gear system further comprises a free spinning secondary gear configured to engage with the fixed secondary gear.

In another aspect, disclosed herein is a hair care device, including the dispenser of disclosed herein.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

FIG. 1 is an example device, in accordance with the present technology;

FIG. 2 is an internal view of an example device, in accordance with the present technology;

FIG. 3 is an internal view of another example device, in accordance with the present technology;

FIG. 4A is an example dispenser system, in accordance with the present technology; and

FIG. 4B is an example second gear system, in accordance with the present technology.

The foregoing aspects and many of the attendant advantages of this invention will become more readily appreciated as the same become better understood by reference to the following detailed description, when taken in conjunction with the accompanying drawings.

### DETAILED DESCRIPTION

Disclosed herein are devices, dispensing systems, and methods for driving two or more pump rollers with a single motor. In some embodiments, a mechanical gear switch-controlled pump roller with specified gear ratios to switch alternate between mix ratios is used. In some embodiments, the gear mechanism used provides the ability to control a second pump roller with one motor. In some embodiments, gears are changed using a sliding synchronizer powered by a keyed latch mechanism.

In some embodiments, the dispensing systems include a single motor, two or more pump rollers, where each pump roller is configured to dispense a formula, and two gear systems disposed on a first shaft and a second shaft. In some embodiments, a first gear system includes a first gear and a second gear, configured to selectively engage a third gear and a fourth gear of a second gear system. In some embodiments, the second gear system further includes a synchronizer configured to switch between the third and fourth gear. Sizes of the gears may control a mix ratio between a first formula and a second formula.

This allows for a device or dispensing system with separately controlled pump rollers to adjust flow of different formulas. In some embodiments, the gear ratios achieve a desired mix ratio of product from two channels. Further the sliding gear synchronizer may be configured to alternate between gears. Levers or automated mechanisms can be used to alternate between gears.

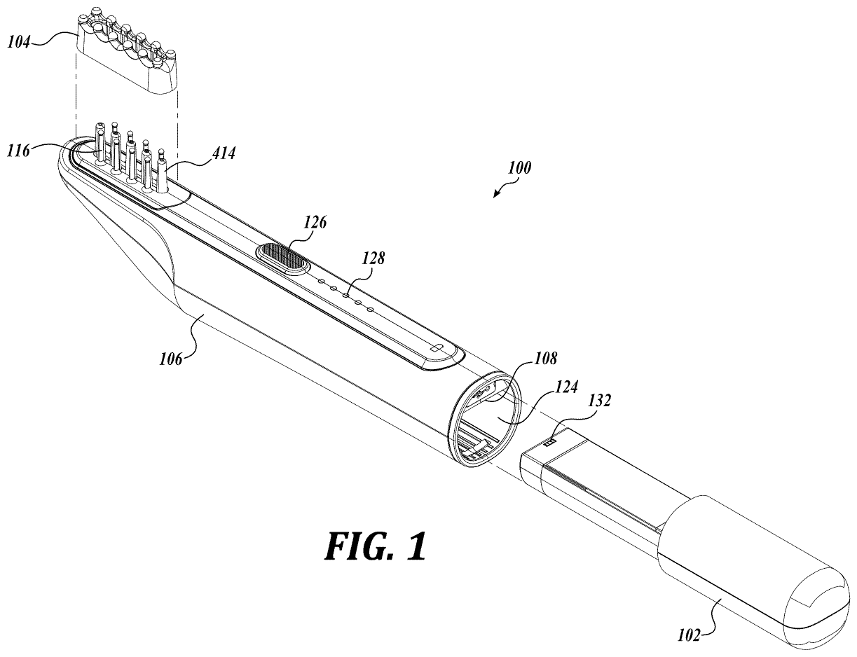

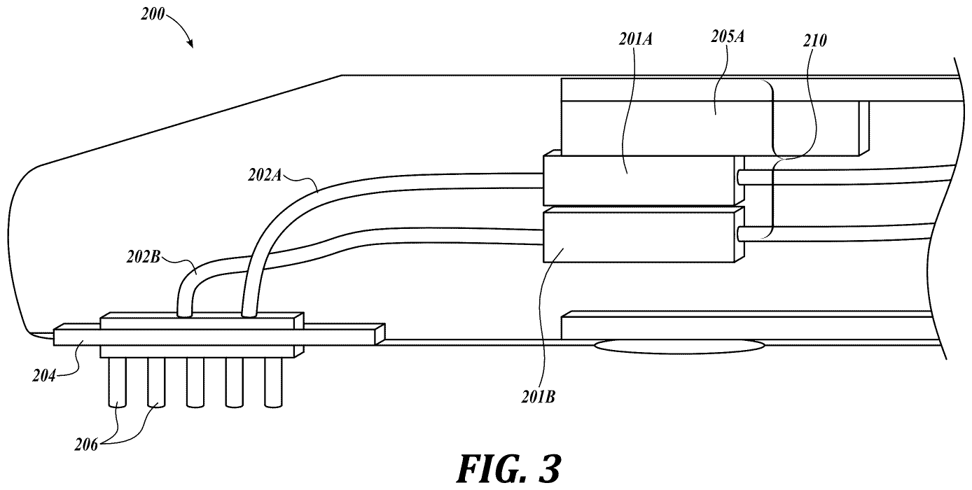

FIG. 1 is an example device 100, in accordance with the present technology. Illustrated is a representative formulation delivery device 100, and components thereof, in accordance with an embodiment of the present disclosure. In some embodiments, the device 100 may be referred to as a “hair care device” or “formulation delivery device.” The formulation delivery device 100 is configured to receive a formulation cartridge 102 type (including a cleaning cartridge of the same type). An embodiment of a formulation cartridge of the formulation cartridge 102 type is described below in detail with respect to FIG. 3; the formulation cartridge 102 shown in FIG. 1 shall be understood to have the same features as described there. Some embodiments of formulation delivery device 100 include the formulation cartridge 102 and/or an optional pull through adapter 104.

Formulation delivery device 100 includes a reusable handle 106 formed from an ABS plastic or similar rigid polymer or other material, and in some embodiments is an assembly formed from a plurality of shells configured to be joined together with fastening elements such as snaps, screws, or the like. Reusable handle 106 has a hollow, elongate gripping portion with a cartridge cavity therein which is sized and dimensioned to receive the formulation cartridge 102 type. In some embodiments, the cavity includes keying features that facilitate correct insertion of the formulation cartridge 102 type. For example, some embodiments include a cartridge interface 108 disposed in the opening and having a flat docking surface that interfaces with a corresponding docking surface of the formulation cartridge 102 when the latter is correctly inserted into the opening.

A controller (not shown in FIG. 1) includes logic configured for operation on a non-transitory machine-readable storage medium, and includes modules that personalize the user experience, provide helpful analytics, and enable e-commerce. In some embodiments, a corresponding application runs on a mobile device such as a smartphone, a tablet, or the like, and interacts with a user (e.g., an end user or a salon technician) to provide actionable information through a plurality of modules. In some embodiments, the application communicates with the formulation delivery device 104 and a network, such as a mobile network, a cloud-based enterprise network, a local area network, or the like.

Together, the formulation cartridge 102, formulation delivery device 104, and application provide an improved, customized, user experience. In some embodiments, the formulation delivery device 104 is a connected electromechanical appliance that interacts with the user, with formulation cartridges 102, and optionally with the application in order to provide a customized and personalized user experience.

Generally, formulation delivery device 104 includes a reusable handle 106 configured to receive the formulation cartridge 102 type, as well as a formulation dispensing assembly and a controller, both disposed in the reusable handle. The formulation dispensing assembly comprises at least one fluid conduit fluidically connected to a motorized pump and to a reciprocating nozzle assembly and is configured to draw formulation or cleaning liquid from the formulation cartridge 110 and to dispense the same through the reciprocating nozzle assembly onto a hair portion, scalp portion, or body portion of a user.

The controller is configured to toggle between at least a cleaning routine and formulation routine responsive to one or more inputs indicative of the cleaning cartridge or the formulation cartridge 102 inserted into the reusable handle 106.

In some embodiments, the formula delivery device 104 further includes a cartridge interface 108 configured to accept the formula cartridge 102, a reciprocating nozzle assembly 114 configured to move a plurality of nozzles or standoff protrusions 116, a button 126 to operate the formula delivery device 104, visual indicators 128 (such as light-emitting diodes (LEDs)) indicating a status of the formula delivery device 104, a cartridge cavity 124 configured to accept the formula cartridge 102, and an encryption chip 132.

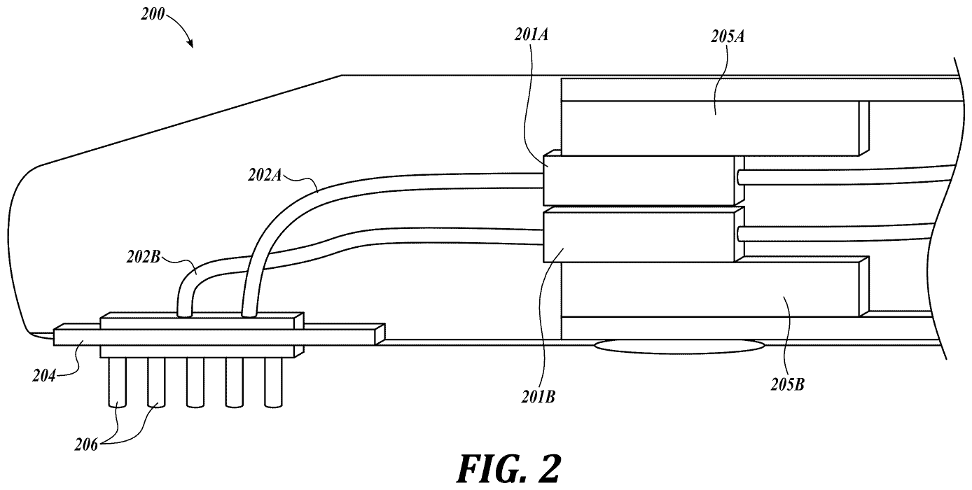

FIG. 2 is an internal view of an example device 200, in accordance with the present technology. In some embodiments, the device 200 may be referred to as a “hair care device” or “formulation delivery device.” In some embodiments, the device 200 includes a first roller pump (or “first peristaltic pump”) 201A, a second roller pump (or “second peristaltic pump”), a first formula tube 202A, a second formula tube 202B, a mixing chamber 204 (which may include a mixer, such as a static mixer), a first motor 205A, a second motor 305B, and a plurality of dispensing nozzles 206.

In operation, the first tube 202A is configured to direct a first formulation, while the second tube 202B directs a second formulation. In some embodiments, the first roller pump 201A dispenses the first formulation at a first flow rate into the mixing chamber 204 through the first tube 202A. Similarly, the second roller pump 201B may dispense the second formulation at a second flow rate into the mixing chamber 204 through the second tube 202B. The first roller pump 201A may be driven by a first motor 205A, while the second roller pump 201B may be driven by a second motor 205B. In some embodiments, both the first roller pump 201A and the second roller pump 201B may modify the flow rate (i.e., the first flow rate and/or the second flow rate) of the first formulation and the second formulation.

Once in the mixing chamber 204, a mixer, such as a static mixer (not shown in FIG. 2) may mix the first formulation and the second formulation. In some embodiments, the first formulation and the second formulation are then dispensed from the plurality of nozzles 206.

FIG. 3 is an internal view of another example device 200, in accordance with the present technology. In some embodiments, the device 200 may be referred to as a “hair care device” or “formulation delivery device.” In some embodiments, the device 200 includes only a single motor 210. In such embodiments, the motor 205, the first pump 201A, and the second pump 201B may be referred to collectively as a dispensing system 210. In some embodiments, a single motor 205 drives both the first pump 201A and the second pump 201B.

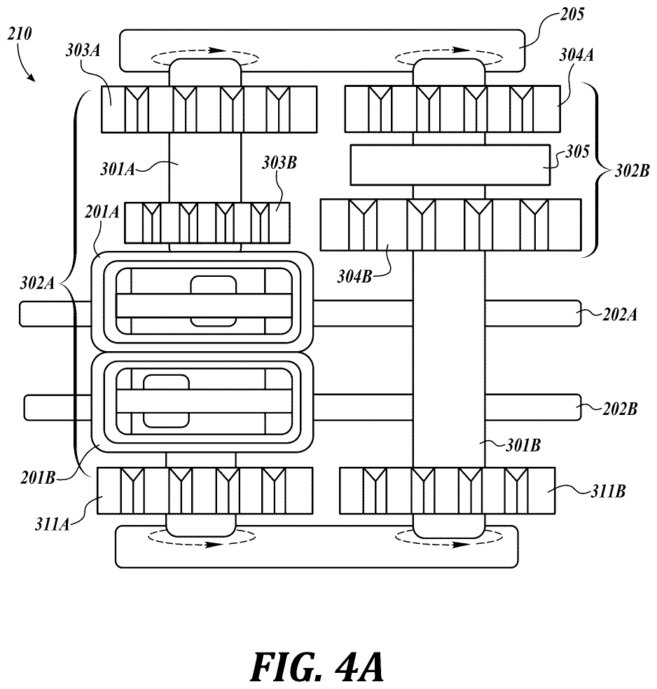

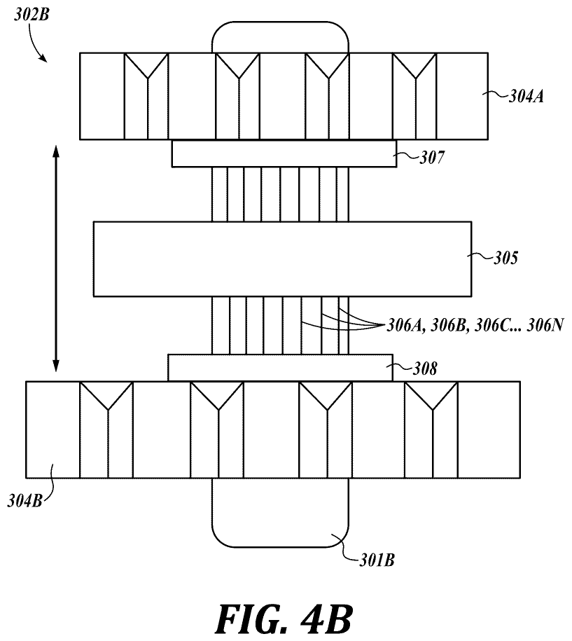

FIG. 4A is an example dispenser system 210, in accordance with the present technology. In some embodiments, the dispenser system 210 is integrated into a device (such as device 100 or device 200). In some embodiments, the dispenser system 210 is separate from a device.

In some embodiments, the dispenser system 210 includes a first shaft 310A and a second shaft 310B. In some embodiments, the first shaft 310A, the second shaft 310B, or a combination thereof may be driven by a motor 205. In some embodiments, both the first shaft 310A and the second shaft 310B are driven by the same motor 210. In some embodiments, the first shaft 310A, the second shaft 310B, or a combination thereof may be driven to rotate, such as shown by the arrows in FIG. 4A.

In some embodiments, the dispenser system 210 further includes a first gear system 302A disposed on the first shaft 301A. The first gear system 302A may include a first gear 303A, a second gear 303B, a first pump roller 201A configured to dispense a first formula, and a second pump roller 201B configured to dispense a second formula. While only two pump rollers 201A, 201B are illustrated, it should be understood that any number of pump rollers may be included in the first gear system 302A. In some embodiments, the motor 205 is further configured to control both the first pump roller 201A and the second pump roller 201B.

In some embodiments, the dispenser system 210 further includes a second gear system 302B disposed on the second shaft 301B. The second gear system 302B may include a third gear 304A, a fourth gear 304B and a synchronizer 305 configured to slide between the third gear 304A and the fourth gear 304B, as shown in more detail in FIG. 4B.

In operation, the first gear 303A is configured to engage the third gear 304A, as shown in detail in FIG. 5A. In some embodiments, a gear ratio between the first gear 303A and the third gear 304A determines a mix ratio of the first formula and the second formula. Similarly, in some embodiments, the second gear 303B is configured to engage the fourth gear 304B, as shown in detail in FIG. 5B. In some embodiments, a gear ratio between the second gear 303B and the fourth gear 304B determines a mix ratio of the first formula and the second formula. For example, in some embodiments, the gear ratio between the first gear 303A and the third gear 304A changes a flow rate of the first roller pump 201A, the second roller pump 201B, or both. Similarly, in some embodiments, the gear ratio between the second gear 303B and the fourth gear 304B changes a flow rate of the first roller pump 201A, the second roller pump 201B, or both.

As used herein, the term “gear ratio” is understood to mean a ratio between the number of teeth in a gear (such as the first gear 303A and the second gear 303B) and in a gear that interfaces with it (such as the third gear 304A and the fourth gear 304B, respectively). Described another way, the gear ratio is the number of turns the third gear 304A or the fourth gear 304B makes while the first gear 303A or the second gear 303B, respectively, make a single turn.

In some embodiments, the gear ratio of the first gear 303A to the third gear 304A is 1:1. In some embodiments, the gear ratio of the second gear 303B to the fourth gear 304B is 2:1. One skilled in the art will recognize that the size of the gears (i.e., first gear 303A, second gear 303B, third gear 304A, fourth gear 304B) may be modified to modify the gear ratio, and thus the mix ratio of the first formula and the second formula. In some embodiments, the mix ratio may be based on a viscosity of the first formula and/or the second formula. In some embodiments, the mix ratio may be based on an identity of the first formula and/or the second formula. For example, if the first formula was hair color, and the second formula was hair developer, a 1:1 ratio may be desired for a vibrant color, and a 1:2 ratio may be desired for root covering or to conceal gray hair.

In some embodiments, the gear ratio of the first gear 303A and the third gear 304A controls a flow rate of the first formula and the second formula. In some embodiments, the gear ratio of the first gear 303A and the third gear 304A controls a mix ratio between the first formula and the second formula.

In some embodiments, the gear ratio of the second gear 303B and the fourth gear 304B controls a flow rate of the first formula and the second formula. In some embodiments, the gear ratio of the second gear 303B and the fourth gear 304B controls a mix ratio of the first formula and the second formula.

In some embodiments, the first gear 303A is fixed. As used herein, a gear is “fixed” if it rotates with the shaft it is located on. Accordingly, in embodiments where the first gear 303A is fixed, it rotates with the first shaft 301A. In some embodiments, the second gear 303B is fixed. In some embodiments, both the first gear 303A and the second gear 303B are fixed.

In some embodiments, the third gear 304A is free spinning. As used herein, a gear is “free spinning” if it does not rotate with the shaft it is disposed on, but rather can be rotated by a fixed gear engaged with it. Accordingly, in embodiments where the third gear 304A is free spinning, it may spin independent of the second shaft 301B when it is engaged by the fixed first gear 303A. In some embodiments, the fourth gear 304B is free spinning. Accordingly, in embodiments where the fourth gear 304B is free spinning, it may spin independent of the second shaft 301B when it is engaged by the fixed third gear 303B.

In some embodiments, the first formula is different from the second formula. In some embodiments, the first formula is a hair dye. In some embodiments, the second formula is a developer. In some embodiments, the first formula, the second formula, or both may be selected from shampoo, conditioner, hair mask, moisturizer, cosmetics, hair chalk, hair pigment, or the like.

In some embodiments, the second gear system 302A further comprises a fixed secondary gear 311B. In some embodiments, the fixed secondary gear 311B is fixed, but in other embodiments, it may be free spinning as described herein. In some embodiments, the first gear system 302A further comprises a free spinning secondary gear 311A configured to engage with the fixed secondary gear 311B.

In operation, the first gear 303A and the third gear 304A are coupled. When the first gear 303A and the third gear 303B are engaged, the synchronizer 305 may be engaged with the third gear 304A. A gear ratio between the first gear 303A and the third gear 304A controls the first roller pump 201A and/or the second roller pump 201B. The rotation of first shaft 301A, the second shaft 301B, or both may be controlled by the motor 205, driving the first roller pump 201A and the second roller pump 201B. In some embodiments, the gear ratio of the first gear 303A and the third gear 304A is 1:1. In some embodiments, a user or a device (such as devices 100, 200) may direct the dispensing system 210 to change the mix ratio and/or gear ratio. The synchronizer 305 may slide between the third gear 304A and the fourth gear 304B to disengage from the third gear 304A and engage the fourth gear 304B, as shown in detail in FIG. 5B. As the synchronizer 305 engages the fourth gear 304B, which is engaged with the second gear 303B, the gear ratio between the second gear 303B and the fourth gear 304B controls the first roller pump 201A and/or the second roller pump 201B. The rotation of first shaft 301A, the second shaft 301B, or both may be controlled by the motor 205, driving the first roller pump 201A and the second roller pump 201B. In some embodiments, the gear ratio of the second gear 303B and the fourth gear 304B is 1:2. In this manner, the device or the dispensing system 210 independently of a device may switch between different gear ratios, and thus different mix ratios, of the first formula and the second formula, with a single motor 205.

It should be understood that the distance between the first gear 303A and the third gear 304A and the distance between the third gear 303B and the fourth gear 304B is for clarity of illustration. In some embodiments, the first gear 303A and the third gear 304A are engaged, that is, the teeth of the first gear 303A and the teeth of the third gear 304A interlock, such that the first gear 303A and the third gear 304A are coupled. Further, in some embodiments, the second gear 303B and the fourth gear 304B are engaged, that is, the teeth of the second gear 303B and the teeth of the fourth gear 304B interlock, such that the second gear 303A and the fourth gear 304B are coupled.

FIG. 4B is an example second gear system 302B, in accordance with the present technology. In some embodiments, the third gear 304A includes a third gear attachment 307 configured to removably couple to the synchronizer 305. In some embodiments the third gear attachment 307 is a key latch attachment. In some embodiments, the third gear attachment 307 is a smaller, internal gear. In some embodiments, the fourth gear 304B includes a fourth gear attachment 308 configured to removably couple to the synchronizer 305. In some embodiments the fourth gear attachment 308 is a key latch attachment. In some embodiments, the fourth gear attachment 308 is a smaller, internal gear.

In some embodiments, the synchronizer 305 slides laterally along fixed shaft splines 306A, 306B, 306C . . . 306N of the second shaft 301B. The fixed shaft splines 306A, 306B, 306C . . . 306N may transfer torque to the synchronizer 305. In operation, the synchronizer 305 is configured to adjust the speed of the second shaft 301B to match the gear to be engaged (i.e., the third gear 304A or the fourth gear 304B) allowing for smooth gear changes between the third gear 304A and the fourth gear 304B.

The present application may reference quantities and numbers. Unless specifically stated, such quantities and numbers are not to be considered restrictive, but representative of the possible quantities or numbers associated with the present application. Also, in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, the phrase “at least one of A, B, and C,” for example, means (A), (B), (C), (A and B), (A and C), (B and C), or (A, B, and C), including all further possible permutations when greater than three elements are listed.

Embodiments disclosed herein may utilize circuitry in order to implement technologies and methodologies described herein, operatively connect two or more components, generate information, determine operation conditions, control an appliance, device, or method, and/or the like. Circuitry of any type can be used. In an embodiment, circuitry includes, among other things, one or more computing devices such as a processor (e.g., a microprocessor), a central processing unit (CPU), a digital signal processor (DSP), an application-specific integrated circuit (ASIC), a field-programmable gate array (FPGA), or the like, or any combinations thereof, and can include discrete digital or analog circuit elements or electronics, or combinations thereof.

An embodiment includes one or more data stores that, for example, store instructions or data. Non-limiting examples of one or more data stores include volatile memory (e.g., Random Access memory (RAM), Dynamic Random Access memory (DRAM), or the like), non-volatile memory (e.g., Read-Only memory (ROM), Electrically Erasable Programmable Read-Only memory (EEPROM), Compact Disc Read-Only memory (CD-ROM), or the like), persistent memory, or the like. Further non-limiting examples of one or more data stores include Erasable Programmable Read-Only memory (EPROM), flash memory, or the like. The one or more data stores can be connected to, for example, one or more computing devices by one or more instructions, data, or power buses.

In an embodiment, circuitry includes a computer-readable media drive or memory slot configured to accept signal-bearing medium (e.g., computer-readable memory media, computer-readable recording media, or the like). In an embodiment, a program for causing a system to execute any of the disclosed methods can be stored on, for example, a computer-readable recording medium (CRMM), a signal-bearing medium, or the like. Non-limiting examples of signal-bearing media include a recordable type medium such as any form of flash memory, magnetic tape, floppy disk, a hard disk drive, a Compact Disc (CD), a Digital Video Disk (DVD), Blu-Ray Disc, a digital tape, a computer memory, or the like, as well as transmission type medium such as a digital and/or an analog communication medium (e.g., a fiber optic cable, a waveguide, a wired communications link, a wireless communication link (e.g., transmitter, receiver, transceiver, transmission logic, reception logic, etc.). Further non-limiting examples of signal-bearing media include, but are not limited to, DVD-ROM, DVD-RAM, DVD+RW, DVD-RW, DVD-R, DVD+R, CD-ROM, Super Audio CD, CD-R, CD+R, CD+RW, CD-RW, Video Compact Discs, Super Video Discs, flash memory, magnetic tape, magneto-optic disk, MINIDISC, non-volatile memory card, EEPROM, optical disk, optical storage, RAM, ROM, system memory, web server, or the like.

The detailed description set forth above in connection with the appended drawings, where like numerals reference like elements, are intended as a description of various embodiments of the present disclosure and are not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result. Generally, the embodiments disclosed herein are non-limiting, and the inventors contemplate that other embodiments within the scope of this disclosure may include structures and functionalities from more than one specific embodiment shown in the figures and described in the specification.

In the foregoing description, specific details are set forth to provide a thorough understanding of exemplary embodiments of the present disclosure. It will be apparent to one skilled in the art, however, that the embodiments disclosed herein may be practiced without embodying all the specific details. In some instances, well-known process steps have not been described in detail in order not to unnecessarily obscure various aspects of the present disclosure. Further, it will be appreciated that embodiments of the present disclosure may employ any combination of features described herein.

The present application may include references to directions, such as “vertical,” “horizontal,” “front,” “rear,” “left,” “right,” “top,” and “bottom,” etc. These references, and other similar references in the present application, are intended to assist in helping describe and understand the particular embodiment (such as when the embodiment is positioned for use) and are not intended to limit the present disclosure to these directions or locations.

The present application may also reference quantities and numbers. Unless specifically stated, such quantities and numbers are not to be considered restrictive, but exemplary of the possible quantities or numbers associated with the present application. Also, in this regard, the present application may use the term “plurality” to reference a quantity or number. In this regard, the term “plurality” is meant to be any number that is more than one, for example, two, three, four, five, etc. The term “about,” “approximately,” etc., means plus or minus 5% of the stated value. The term “based upon” means “based at least partially upon.”

The principles, representative embodiments, and modes of operation of the present disclosure have been described in the foregoing description. However, aspects of the present disclosure, which are intended to be protected, are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure as claimed.

While illustrative embodiments have been illustrated and described, it will be appreciated that various changes can be made therein without departing from the spirit and scope of the invention.

We claim:

1. A dispenser system, comprising:
a first shaft and a second shaft;
a first gear system disposed on the first shaft, the first gear system comprising:
a first gear;
a second gear;
a first pump roller configured to dispense a first formula; and
a second pump roller configured to dispense a second formula;
a second gear system disposed on the second shaft, the second gear system comprising:
a third gear;
a fourth gear; and
a synchronizer configured to slide between the third gear and the fourth gear; and
a motor configured to rotate the first shaft and the second shaft, wherein the motor is configured to control both the first pump roller and the second pump roller.

2. The dispenser system of claim 1, wherein the first gear is configured to engage the third gear.

3. The dispenser system of claim 1, wherein the second gear is configured to engage the fourth gear.

4. The dispenser system of claim 1, wherein a gear ratio of the first gear to the third gear is 1:1.

5. The dispenser system of claim 1, wherein a gear ratio of the second gear to the fourth gear is 2:1.

6. The dispenser system of claim 1, wherein the first gear is fixed.

7. The dispenser system of claim 1, wherein the second gear is fixed.

8. The dispenser system of claim 1, wherein the third gear is free spinning.

9. The dispenser system of claim 1, wherein the fourth gear is free spinning.

10. The dispenser system of claim 1, wherein the first formula is different from the second formula.

11. The dispenser system of claim 1, wherein a gear ratio of the first gear and the third gear controls a flow rate of the first formula and the second formula.

12. The dispenser system of claim 1, wherein a gear ratio of the first gear and the third gear controls a mix ratio between the first formula and the second formula.

13. The dispenser system of claim 1, wherein a gear ratio of the second gear and the fourth gear controls a flow rate of the first formula and the second formula.

14. The dispenser system of claim 1, wherein a gear ratio of the second gear and the fourth gear controls a mix ratio of the first formula and the second formula.

15. The dispenser system of claim 1, wherein the synchronizer slides laterally along fixed shaft splines of the second shaft.

16. The dispenser system of claim 1, wherein the third gear comprises a third gear attachment configured to removably couple to the synchronizer.

17. The dispenser system of claim 1, wherein the fourth gear comprises a fourth gear attachment configured to removably couple to the synchronizer.

18. The dispenser system of claim 1, wherein the second gear system further comprises a fixed secondary gear.

19. The dispenser system of claim 18, wherein the first gear system further comprises a free spinning secondary gear configured to engage with the fixed secondary gear.

20. A hair care device, comprising the dispenser of claim 1.
